(19) United States
(12) Patent Application Publication
(10) Pub. No.: US 2007/0006242 A1
(43) Pub. Date: Jan. 4, 2007

(54) Disk drive equipped with tray

(76) Inventor: Hirotoshi Hara, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/408,996

(22) Filed: Apr. 24, 2006

(30) Foreign Application Priority Data
Jun. 30, 2005 (JP) 2005-191254

(51) Int. Cl. G11B 17/04

(52) U.S. Cl. 720/613

(57) ABSTRACT

To provide a disk drive equipped with a tray that moves along a guide rail provided on a body frame in which the tray does not tilt downward under its own weight when extended, rails are provided along both sides of the tray, and a plurality of guide ribs are provided on both sidewalls of the body frame projecting inwardly therefrom for guiding the rails of the tray. A presser rib rises from the bottom of the body frame near the front of the frame and has a contacting part projecting inwardly from its end. A high horizontal rail part higher than the front-end part side is formed on top of a rear end part side of each of the rails, so that the contacting part of the presser rib contacts and presses against the high horizontal rail part.

### BACKGROUND OF THE INVENTION

1. Field of the Invention

The present invention relates to a disk drive equipped with a tray that transports a disk using a sliding mechanism, and more particularly, to a disk drive provided with means for preventing a front-end part of the tray from shaking when the tray is transported to a disk exchange position.

2. Related Art

As an implementation of means for preventing a front-end part of a tray from shaking during transport, the “Sliding Mechanism for Tray of High Accuracy to be Built into Optical Disk Apparatus or the Like” of JP-A-2001-291302 is known. In order to prevent the tray from shaking drastically vertically and horizontally when it is pulled out, a second guide is laid down adjacent to a conventional guide, which is approximately half the length of the full range of movement of the tray. When the tray is slightly extended, the conventional guide and a pin that slidingly engages the guide is used to prevent the tray from shaking, and when the tray is greatly extended, the second guide and a pin that slidingly engages the second guide is used to prevent the tray from shaking. When the extent to which the sliding out of the tray is intermediate between slight and great, the engagement of the tray and the guide-and-pin assemblies is switched so as to prevent both assemblies from acting simultaneously.

In other words, in the sliding mechanism described above, two guides are provided and the engagement of the assemblies is switched according to how much the tray moves so that three pins do not engage simultaneously, thus making it possible to make the engagement accuracy at any of the pins extremely high and thereby allowing the sliding movement of the tray to be smooth and quiet.

However, although such a structure can prevent lateral shaking of the tray, it cannot prevent the front-end part of the tray from tilting downward when the tray is extended so as to transport a disk to a disk exchange position. Furthermore, since a second guide having a length that is half the total range of movement of the tray is provided in addition to the conventional guide, sliding friction attends the extension of the tray from the apparatus and the retraction of the tray into the apparatus, which requires extra power to overcome and necessitates a large motor for the tray drive.

### SUMMARY OF THE INVENTION

Accordingly, the present invention is intended to solve the above-described problem of the conventional art, and has as its object to provide a disk drive equipped with guide means that prevent the front-end part of the tray from tilting under its own weight when extended from the drive body.

To achieve the above-described object, the present invention provides a disk drive including a tray that moves along a guide rail provided on a body frame by a pinion rotated by a motor so as to engage a rack extending longitudinally along a bottom of the tray, rails provided along both sides of the tray, a plurality of guide ribs for guiding the rails of the tray provided on both sidewalls of the body frame so as to project inwardly therefrom, a presser rib rising from a bottom of the body frame near a front of the frame and having a contacting part that projects inwardly from the end the presser rib, a high horizontal rail part higher than a front-end part side formed on top of a rear end part side of each of the rails, the contacting part of the presser rib contacting and pressing against the high horizontal rail part.

Preferably, the presser rib is inclined slightly inward. According to such a structure, the tray causes the presser rib to be bent outward and deformed, increasing the pressure of the contacting part of the presser rib against the rails.

Preferably, a low horizontal rail part is formed on the front-end part side of each of the rails, and the low horizontal rail part and the high horizontal rails are connected by an inclined rail part having a gently inclined surface. Such a structure enables the contacting of the contacting part of the presser rib against the high horizontal rail part to be carried out smoothly.

Preferably, the presser rib and the high horizontal rail part of the rails are positioned so that the contacting part of the presser rib contacts the high horizontal rail part when the tray is at least halfway extended from the body frame. Once the tray is extended halfway out of the body frame it begins to bit downward under its own weight, and therefore the halfway-extension mark is the borderline up to which such downward tilting can be prevented.

With the disk drive according to the present invention, the presser rib contacts the rail before the center of gravity of the extended tray passes the front of the body frame and the second guide rib from the front end side separates from the rail, and thus the front end of the tray does not tit downward. In other words, before the tray is extended and begins to bit, the presser rib contacts the high horizontal rail part position and prevents tilting. Therefore, pressure from the presser rib does not act on the low horizontal rail part position before the presser rib contacts the high horizontal rail part, and thus the provision of the presser rib does not increase the tray transport power beyond what is required.

Furthermore, the presser rib is constructed so as to bend and be deformable in the direction in which the contacting part withdraws from the rail, and therefore, when the presser rib contacts the sliding high horizontal rail part, excessive load due to sliding friction does not arise. Preventing tilting of the tray as described above stabilizes both the engagement of the rack provided on the bottom of the tray and the pinion that is the drive transmission mechanism.

Other objects, features and advantages of the present invention will be apparent from the following description when taken in conjunction with the accompanying drawings, in which like reference characters designate the same or similar parts throughout the figures thereof.

### BRIEF DESCRIPTION OF THE DRAWINGS

FIG. 1 is a plan view of a disk drive according to one embodiment of the present invention;

FIG. 2 is a plan view of the disk drive with the tray removed;

FIG. 3 is a perspective view of the tray of the disk drive;

FIG. 4 is a perspective view of a front side portion of a body frame of a disk drive;

FIG. 5 is a perspective view of a presser rib provided on a sidewall of the body frame;

FIG. 6A is a cross-sectional view of the body frame where the presser rib is located and FIG. 6B is an enlarged sectional view of a part A shown in FIG. 6A;

FIG. 7A is a cross-sectional view of a state in which the presser rib engages the tray and FIG. 7B is an enlarged sectional view of a part B shown in FIG. 7A;

FIG. 8A is a sectional side elevation view of the disk drive in which the tray is at a disk reproducing position, and FIG. 8B is a sectional side elevation view of the disk drive in which the tray is at a disk exchange position;

FIG. 9 is a plan view of the disk drive in a state in which the tray is extended slightly;

FIG. 10 is a plan view of the disk drive in a state in which the tray is extended approximately halfway; and

FIG. 11 is a plan view of a disk drive in a state in which the tray is fully extended to a disk exchange position.

### DETAILED DESCRIPTION OF THE PREFERRED EMBODIMENTS

A detailed description will now be given of a preferred embodiment of the present invention, with reference to the drawings.

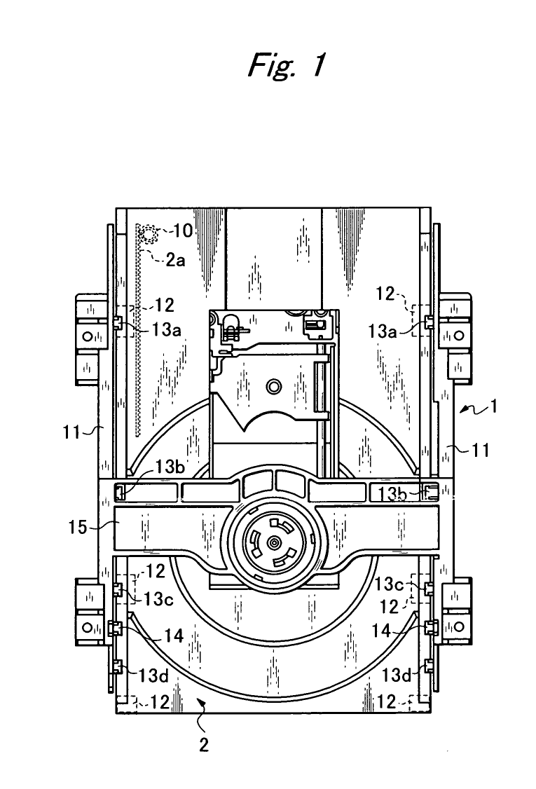

As shown in FIG. 1, the disk drive according to one embodiment of the present invention comprises a plurality of guide ribs 13a, 13b . . . provided on each of lateral sidewalls 11 provided on both lateral sides of a body frame 1 and a tray 2 slidably guided by guide rails 12 provided near the sidewalls 11, 11 and the guide ribs 1-3a, 13b . . . . Presser ribs 14, 14 that press the tray 2 from above are provided near the front side of the lateral sidewalls 11,11.

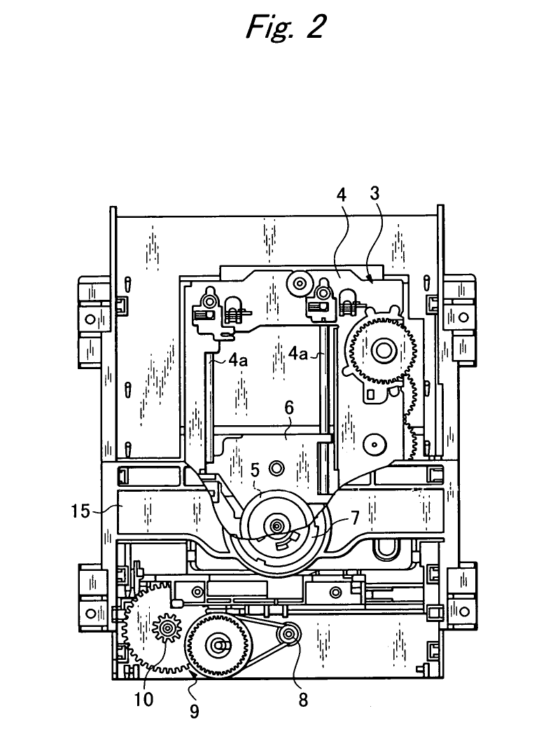

In addition, as shown in FIG. 2, the disk drive is equipped with a traverse unit 3 composed of a turntable 5 on which a disk inserted into the body frame 1 by the tray 2 is set and rotated, and a pick-up unit 6 for reading information recorded on a disk and mounted so as to be movable along guide shafts 4a, 4a on top of a traverse chassis 4 mounted inside the body frame 1 in such a way that a front side thereof is vertically movable using a back end thereof as a hinge. Further, a damper 7 for clamping a disk set on the turntable 5 so as to keep the disk from slipping off the turntable 5 is mounted on the center of a damper support 15 that straddles a space between the lateral sidewalls 11,11.

A motor that is the drive source for transporting the tray 2 is disposed on the front of the traverse unit 3 inside the body frame 1. A pulley 8 mounted on the shaft of the motor drives a pinion 10 through a power transmission mechanism 9. The pinion 10 is mounted so that it can engage a rack 2a provided on the bottom of the tray 2.

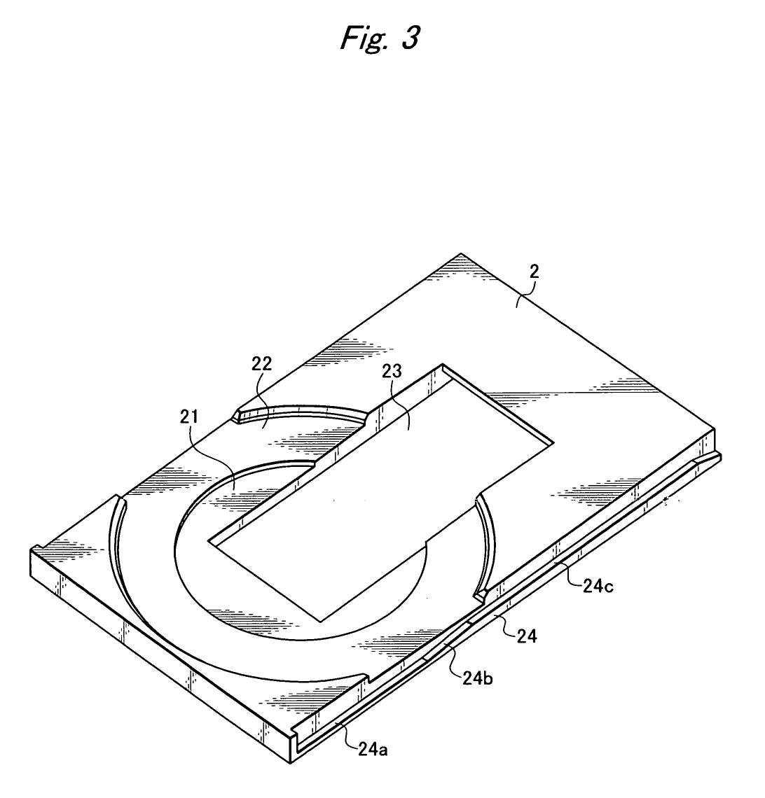

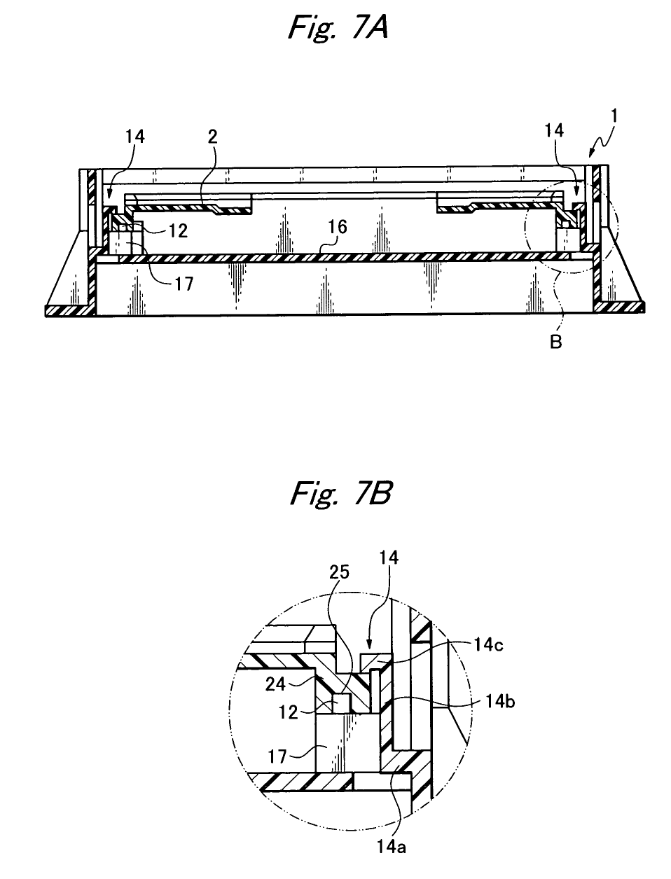

As shown in FIG. 3, depressions 21, 22 in which disks are placed are formed in the center of the front-end side of the tray 2, and a rectangular through-hole 23 is formed in the center of the tray 2. The pick-up unit 6 is positioned in the through-hole 23. The pick-up unit 6 reads information recorded on a disk while moving along the guide shafts 4a, 4a as the disk rotates. Rails 24, 24 are formed on both lateral sides of the tray 2. From the front end side (the front side) moving toward the rear, each rail 24 is formed continuously of a low horizontal rail part 24a, an inclined rail part 24b, and a high horizontal rail part 24c. The rails and the tray 2 are formed as a single unit, and a guide groove 25 is formed in the bottom of each of the rails 24 (see FIG. 7B).

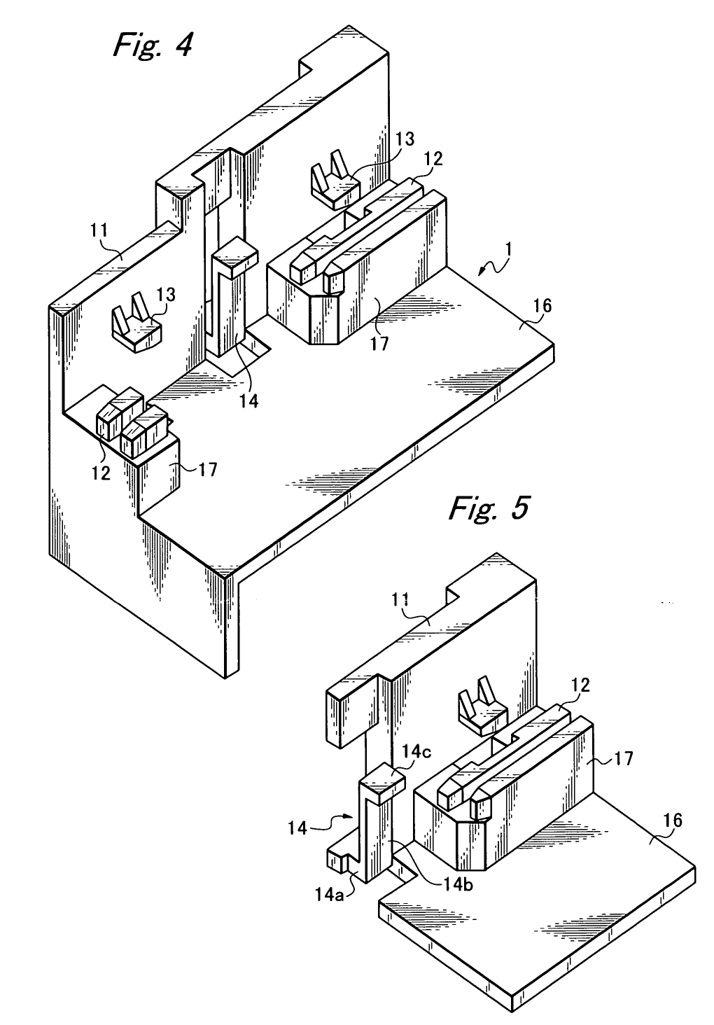

As shown in FIG. 4, inwardly projecting guide ribs 13, 13 are provided on each sidewall 11 toward the front of the body frame 1, with the bottoms of the guide ribs 13,13 forming guide surfaces that are contacted by the tops of the rails 24. In addition, a pedestal 17 is formed in a comer between the bottom 16 of the body frame 1 and the sidewalls 11, in the top of which a guide rail 12 is formed. Furthermore, the presser rib 14 for pressing on the tray 2 from above is provided at a portion cut out of the sidewalls 11 and the bottom 16 at a location intermediate between the two guide ribs 13,13.

As shown in FIG. 5, the presser rib 14 is composed of a base 14a that is flush with the surface of the bottom 16, a support 14b rising perpendicularly from the end of the base 14a, and a contacting part 14c that projects inward from the end of the support 14b. The support 14b is deformable about the base 14a, and as a result the height of the contact can be changed slightly. The support 14b need not rise perpendicularly from the base 14a, and alternatively, may be inclined slightly inward.

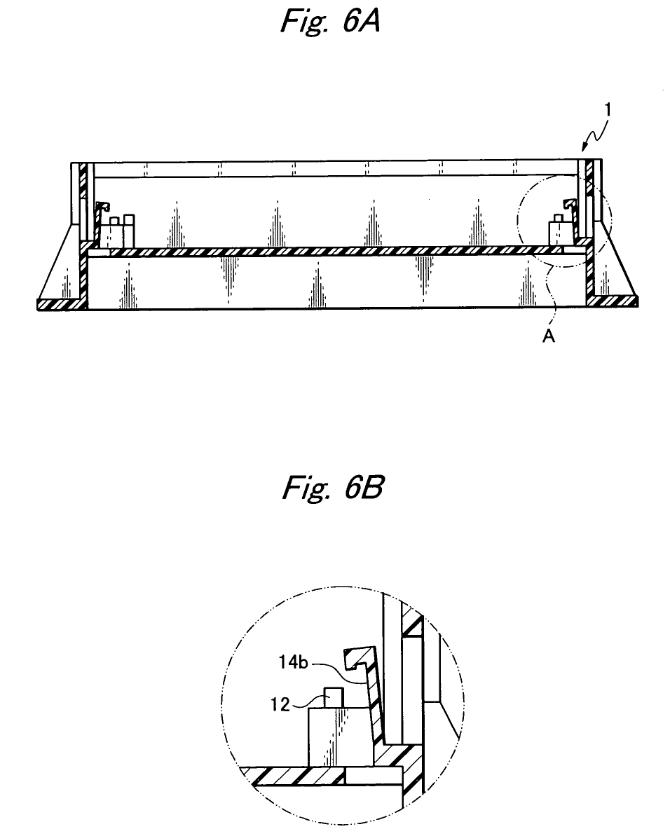

FIGS. 6A through 7B show a case in which the support 14b of the presser rib 14 is inclined inward. When the tray 2 is at a disk reproducing position, the rails 24 located on both lateral sides of the tray 2 rest atop the pedestals 17 and the guide rails 12 formed on the tops of the pedestals 17 engage the guide grooves 25 formed in the bottoms of the rails 24. In other words, the tray 2 rests on the pedestals 17, thus fixing the position of the tray 2 in the lateral direction. As the tray 2 slides toward the disk exchange position and approaches the high horizontal rail parts 24c, the contacting parts 14c of the presser ribs 14 contact the high horizontal rail parts 24c and deform about their bases 14a in the curve shown in FIG. 7B. As a result, the elastic force of that curve acts on the tops of the high horizontal rail parts 24c so as to exert a force pressing down on the tray 2 from above. Thus, the contacting parts 14c of the presser ribs 14 contact the top of the tray 2 so as to prevent the tray 2 from rising.

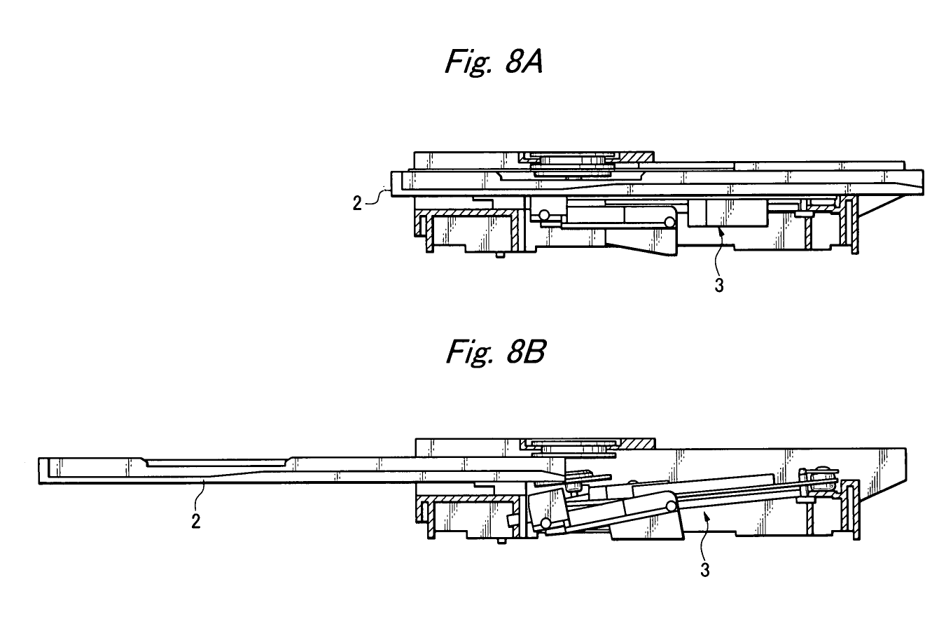

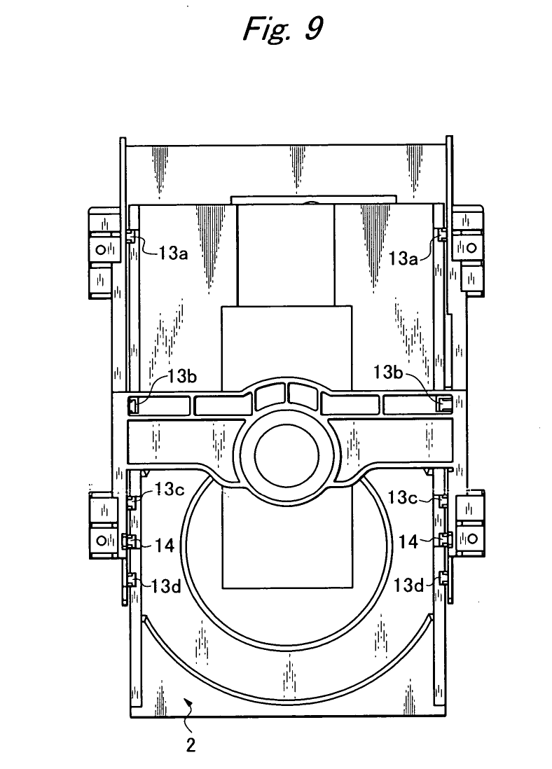

The tray 2 in the disk drive constructed as described above moves reciprocally from the disk reproducing position shown in FIG. 8A to the disk exchange position shown in FIG. 8B and back. However, in the disk reproducing position shown in FIG. 1 and FIG. 8A, the presser ribs 14 exist above the low horizontal rail parts 24a and the contacting parts 14c of the presser ribs 14 do not contact the high horizontal rail parts 24c. Nevertheless, the guide ribs 13a and 13b are in contact with or adjacent to the high horizontal rail parts 24c and thus the tray 2 does not rise. Even in the position shown in FIG. 9, in which the tray 2 is extended slightly, the contacting parts 14c of the presser ribs 14 do not contact the high horizontal rail parts 24c whereas the guide ribs 13a and 13b do contact or approach the high horizontal rail parts 24c.

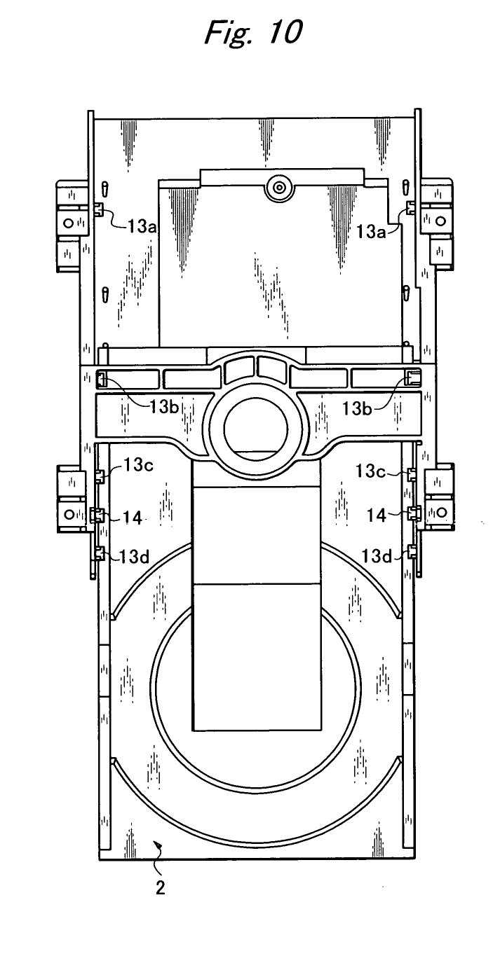

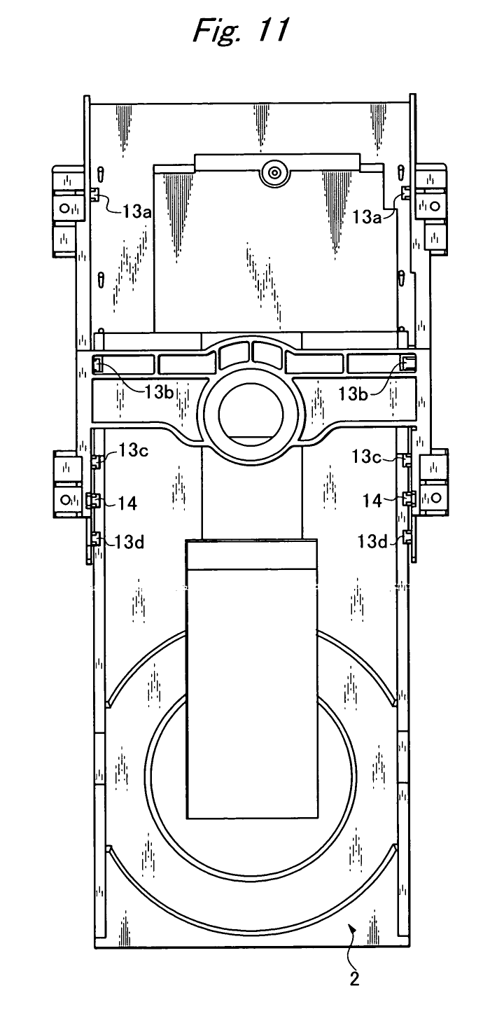

In the position shown in FIG. 10, in which the trays is extended approximately halfway, the center of gravity of the tray 2 is outside the body frame 1 and consequently the front-end part of the tray begins to fall under its own weight and tilt downward. However, in such a position, the contacting parts 14c of the presser ribs 14 are already in contact with the high horizontal rail parts 24c of the rails 24, 24. Therefore, the front-end part of the tray 2 does not tilt downward. In such a position, the bottoms of guide ribs 13c, 13d located so as to sandwich the presser rib 14 front and back also approach the high horizontal rail parts 24c, but because the contacting parts 14c of the presser ribs 14 remain in contact with the high horizontal rail parts 24c as described above the bottoms of the guide ribs 13c, 13d do not contact the high horizontal rail parts 24c. This state is the same in the position shown in FIG. 11 as well, in which the tray 2 is extended to the disk exchange position, thus preventing tilting of the tray 2 in a state in which the contacting parts 14c of the presser ribs 14 exert an elastic force on the high horizontal rail parts 24c.

As many apparently widely different embodiments of the present invention can be made without departing from the spirit and scope thereof, it is to be understood that the invention is not limited to the specific embodiment thereof and described herein except as defined in the appended claims.

What is claimed is:

1. A disk drive comprising a tray that moves along a guide rail provided on a body frame by a pinion rotated by a motor so as to engage a rack extending longitudinally along a bottom of the tray,
rails provided along both sides of the tray,
a plurality of guide ribs for guiding the rails of the tray provided on both sidewalls of the body frame so as to project inwardly therefrom,
a presser rib rising from a bottom of the body frame near a front of the frame and having a contacting part that projects inwardly from the end the presser rib,
a high horizontal rail part higher than a front-end part side formed on top of a rear end part side of each of the rails,
the contacting part of the presser rib contacting and pressing against the high horizontal rail part.

2. A disk drive according to claim 1, wherein the presser rib is inclined slightly inward.

3. A disk drive according to claim 1, wherein a low horizontal rail part is formed on the front-end part side of each of the rails,
the low horizontal rail part and the high horizontal rails connected by an inclined rail part having a gently inclined surface.

4. A disk drive according to claim 1, wherein the presser rib and the high horizontal rail part of the rails are positioned so that the contacting part of the presser rib contacts the high horizontal rail part when the tray is at least halfway extended from the body frame.
